(19) United States
(12) Patent Application Publication
(10) Pub. No.: US 2017/0045141 A1
(43) Pub. Date: Feb. 16, 2017

(54) SEAL WITH TWO-PIECE CASING

(71) Applicant: Michael Thomas, Sycamore, IL (US)

(72) Inventor: Michael Thomas, Sycamore, IL (US)

(73) Assignee: AKTIEBOLAGET SKF, GOTEBORG (SE)

(21) Appl. No.: 14/824,516

(22) Filed: Aug. 12, 2015

(51) Int. Cl. F16J 15/3252; F16J 15/328; B23K 31/02; F16J 15/3204

(52) U.S. Cl. CPC F16J 15/3252; F16J 15/3204; F16J 15/328; B23K 31/02

(57) ABSTRACT

A seal and method of forming a seal. The seal includes a casing including a first part and a second part. The first and second parts are separate pieces attached together at a connection location. At least a portion of the first part extends radially inwardly from the second part. The seal also includes a generally annular sealing element coupled with the first part of the casing and configured to seal with a relatively movable member.

### BACKGROUND

Radial seals are used in a variety of industrial contexts. For example, seals may be used to protect a bearing from contaminants and maintain grease or oil therein. The seals generally include a flexible element that engages (or nearly engages) a rotating element, often a shaft, and a more rigid element that connects with a housing or another generally stationary body. The seal thus allows the shaft to rotate (or otherwise move) relative to the housing, while maintaining a seal.

Many different sizes of seals are employed in different machines. Seals are thus often custom-designed for the particular machine in which they are used. Accordingly, relatively small customer orders for such seals may present a challenge, because it may not be practical to maintain a large inventory of every conceivable size of seal. Thus, such small orders may result in essentially a custom manufacturing run of the ordered seal. Typically, manufacturers react by attempting to simplify the manufacturing process, reducing the part count wherever possible. While this may be effective in some contexts, the challenge of inventory limitations may persist, and such small runs may make the seal manufacturing less economical.

### SUMMARY

Embodiments of the disclosure may provide a seal including a casing including a first part and a second part, the first and second parts being separate pieces attached together at a connection location, at least a portion of the first part extending radially inwardly from the second part. The seal also includes a generally annular sealing element coupled with the first part of the casing and configured to seal with a relatively movable member.

Embodiments of the disclosure may also provide a method of forming a seal. The method includes attaching a sealing element to a first, generally radially-extending part of a casing, the sealing element being configured to seal with a relatively movable member. The method also includes modifying a dimension of the first part to meet a specification, and attaching a second, generally axially-extending part of the casing to the first part.

Embodiments of the disclosure may further provide a seal for a shaft. The seal includes a casing including a first part and a second part, the first part having a generally-annular disk shape and defining a radial surface, and the second part having a generally tubular shape including a first axial end and a second axial end, the first axial end of the second part being connected to the radial surface of the first part at a connection location, and at least a portion of the first part extending radially inward from at least a portion of the second part. The seal also includes a generally annular sealing element coupled with the first part of the casing and configured to seal with the shaft.

### BRIEF DESCRIPTION OF THE DRAWINGS

The accompanying drawings, which are incorporated in and constitute a part of this specification, illustrate an embodiment of the present teachings and together with the description, serve to explain the principles of the present teachings.

FIG. 1 illustrates a side, cross-sectional view of a seal, according to an embodiment.

FIG. 2 illustrates a flowchart of a method for forming a seal, according to an embodiment.

It should be noted that some details of the figures have been simplified and are drawn to facilitate understanding of the embodiments rather than to maintain strict structural accuracy, detail, and scale.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

In general, embodiments of the present disclosure may provide a seal with a two-piece casing. First and second parts of the casing may be connected together and connected to a sealing element, e.g., to form a seal around a shaft. The first part of the casing may be connected with the sealing element during the formation process (e.g., molding) of the sealing element, while the second part of the casing may initially remain separate. The first part of the casing may then be cut-to-size, e.g., according to dimensions for an order of seals, and connected proximal to the second part of the casing.

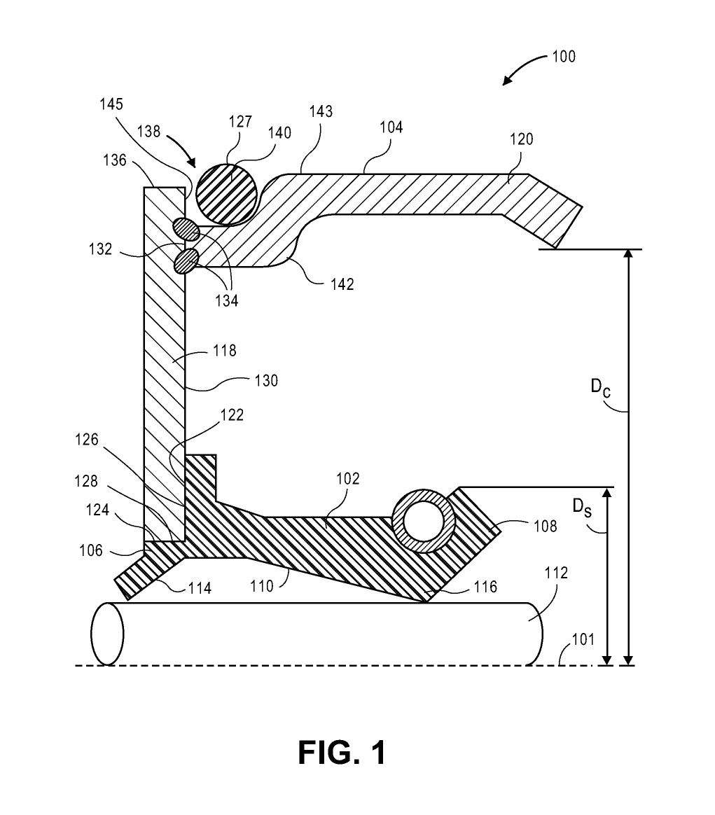

Turning now to the illustrated example embodiments, FIG. 1 illustrates a side, cross-sectional view of a seal 100, according to an embodiment. The seal 100 may be generally annular, and thus it will be appreciated that the illustrated cross-section may extend around a longitudinal axis 101 (horizontal in this view). However, in some embodiments, the cross-section may not remain constant but may have differences along the circumferential direction and/or may not be continuous (e.g., having slots, etc. formed therein), while still remaining within the scope of the term “generally annular.”

The seal 100 may include a sealing element 102 and a casing 104, with the sealing element 102 being coupled with the casing 104, as will be described below. The sealing element 102 may extend axially (i.e., parallel to the longitudinal axis 101) between first and second axial ends 106, 108 and may define an inner circumferential surface 110. The inner circumferential surface 110 may extend axially along a relatively movable member, e.g., a shaft 112, and may be configured to seal with or otherwise engage therewith. To accomplish such sealing with the shaft 112, the sealing element 102 may include one or more lips 114 and/or one or more inner profiles 116. The sealing element 102 may be made of a relatively soft, elastic material, such as rubber or another elastomer. In other embodiments, the sealing element 102 may be made at least partially from a fiber-reinforced material (e.g., a “composite material”), a plastic, or any other suitable material.

The casing 104 may include a first part 118 and a second part 120, which may be separate pieces that are attached together. The first part 118 may extend substantially radially, e.g., may define or otherwise include a disk shape. In other embodiments, however, the first part 118 may extend at least partially axially, may bend, and/or may form any other suitable geometry. Further, the second part 120 may extend axially, e.g., may have a generally tubular shape; however, again, the second part 120 may be bent or otherwise shaped, as desired. The second part 120 may define an inner diameter D_{C} which may be greater than an outer diameter D_{S} of the sealing element 102, such that the second part 120 may be received around and spaced radially apart from the sealing element 102.

The sealing element 102 may also define a shoulder 122 in which the first part 118 of the casing 104 may be received. For example, the shoulder 122 may include an axially-extending surface 124 and a radially-extending surface 126, which may come together at an angle of, for example, about 90 degrees (although any other angle may be defined therebetween). An inner circumferential surface 128 of the first part 118 of the casing 104 may be disposed in engagement with the axially-extending surface 124 and may be joined thereto via bonding and/or any other connection process, material, and/or device. Further, the first part 118 of the casing 104 may define a radial surface 130, which may be at least partially adjacent (e.g., along a radially-inner portion) to the radially-extending surface 126 of the sealing element 102. The radially-extending surface 126 of the sealing element 102 may be connected to the radial surface 130. In some embodiments, the shoulder 122 may include another radially-extending surface, e.g., axially offset from the radially-extending surface 126, such that the inner circumferential surface 128 of the first part 118 is positioned therebetween.

The sealing element 102 may be formed from a molded material, such as an elastomer, a plastic, or another material. The first part 118 of the casing 104 may be formed from a material with a higher melting point than the molded material of the sealing element 104, such as a metal, metal alloy, plastic, fiber-reinforced material (e.g., a “composite”), combinations thereof, or the like. Thus, in some embodiments, the sealing element 102 may be attached to the first part 118 during molding, e.g., with a layer of adhesive bonding material securing the material of sealing element 102 to the first part 118 of the casing 104. In this way, the first part 118 may serve to provide a shape to what may otherwise be a relatively deformable sealing element 102.

The first and second parts 118 and 120 of the casing 104 may be joined together, e.g., after the sealing element 102 is formed or otherwise coupled with the first part 118. For example, the first and second parts 118, 120 may be welded together. As shown, an axial end 132 of the second part 120 may be welded, soldered, bonded, fastened, or otherwise attached to the radial surface 130 of the first part 118, forming one or more weldings, solderings, etc., at one or more connection locations 134. In the illustrated embodiment, the connection locations 134 are at the radially-inward edge between the first part 118 and the second part 120, and at the radially-outward edge therebetween. It will be appreciated that, in some embodiments, one of these connection locations 134 may be omitted or modified. Further, the connection locations 134 may be proximal to an outer circumference 136 of the first part 118. The connection between the first and second parts 118, 120 may be relatively strong and rigid, so as to prevent displacement of the first and second parts 118, 120 from one another.

In an embodiment, the first part 118 and the second part 120 may together define an outer recess 138 in which an outer seal 140 may be positioned. The outer seal 140 may be an O-ring, which may be configured to seal with an outer housing or another structure that is generally stationary relative to the casing 104. The recess 138 may, for example, be formed by an inward bend 142 formed in an outer circumference 143 and proximal to the axial end 132 of the second part 120. Further, the axial end 132 may be inwardly-offset from the outer circumference 136 of the first part 118, such that a radially-extending surface 145 (e.g., an outer portion of the radial surface 130), extending radially inwards from the outer circumference 136 of the first part 118, forms one side of the recess 138.

In other embodiments, the connection location(s) 134 may be located elsewhere. For example, the connection location 134 may be on the outside of the outer circumference 136, such that second part 120 extends axially over the first part 120 and is connected on a radial inside thereof to the first part 118. A variety of other relative orientations and positions of the connection location 134 are contemplated herein.

It will be appreciated that the seal 100 may include one or more other components suitable for the particular application. An example of such a component is a spring 144, which may be positioned proximal to the second end 108 of the sealing element 102, and may apply a radially-inward directed biasing force that tends to maintain the profile 116 in sealing engagement with the shaft 112. Various other sealing lips (e.g., formed between the sealing element 102 and the shaft 112 and/or between the sealing element 102 and the first part 118 of the casing 104), additional seals, other structures, etc., may also be employed without departing from the scope of the present disclosure.

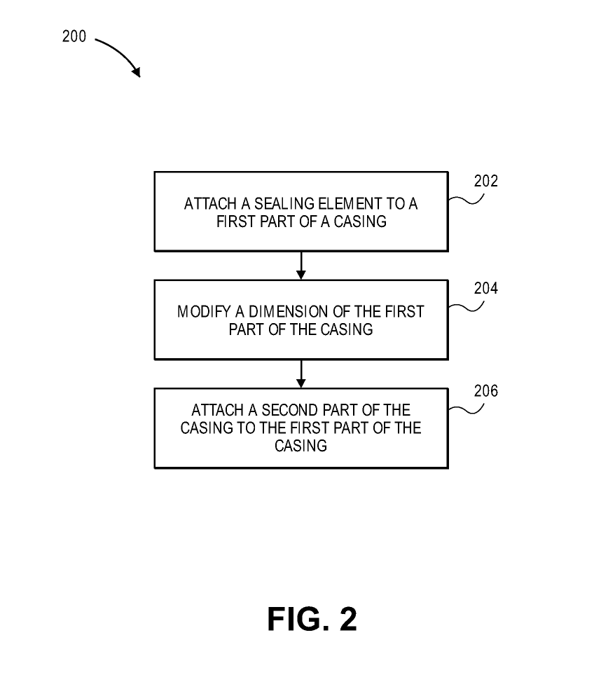

FIG. 2 illustrates a flowchart of a method 200 for forming a seal, according to an embodiment. In some embodiments, execution of the method 200 may result in a seal such as the seal 100, and thus, for convenience, will be described with reference thereto. However, other embodiments of the method 200 may result in different seals, and thus the method 200 is not to be considered limited to any particular structure unless otherwise expressly stated herein.

The method 200 may begin by attaching a sealing element 102 to a first, generally radially-extending part 118 of a casing 104, as at 202. Attaching at 202 may, for example, include bonding the sealing element 102 to the first part 118, molding the sealing element 102 to the first part 118, or both. Further, attaching at 202 may include attaching a shoulder 122 formed in the sealing element 102 to a radial inner portion (e.g., proximal to the inner circumferential surface 128) of the first part 118.

Before, during, or after attaching at 202, the method 200 may also include modifying a dimension (e.g., a diameter) of the first part 118 to meet a specification (e.g., for use in a particular application and/or machine), as at 204. For example, a radial dimension (e.g., outer diameter) of the first part 118 may be reduced by removing an outer portion of the first part 118. In other embodiments, an inner diameter may be increased and/or the first part 118 may be otherwise shaped or resized.

The method 200 may further include attaching a second, generally axially-extending part 120 of the casing 104 to the first part 118, as at 206. Attaching at 206 may occur before, during, or after either attaching at 202 or modifying at 204. Further, attaching at 206 may proceed by welding or soldering the first and second parts 118, 120 together at a connection location 134, e.g., in embodiments in which the first and second parts 118, 120 are formed from compatible materials, such as metals or alloys thereof. In an embodiment, the connection location 134 may be proximal to an outer circumference 136 of the first part 118 of the casing 104. In another embodiment, the connection location 134 may be offset radially inward from the outer circumference 136 of the first part 118 of the casing 104 along the radial surface 130 of the first part 118. For example, the first part 118 and the second part 120 may together define a recess 138 in which an outer seal 140 may be received.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A seal comprising:
a casing including a first part and a second part, the first and second parts being separate pieces attached together at a connection location, at least a portion of the first part extending radially inwardly from the second part; and
a generally annular sealing element coupled with the first part of the casing and configured to seal with a relatively movable member.

2. The seal of claim 1, wherein the second part of the casing includes a generally tubular body defining a central bore, the sealing element being at least partially disposed within the central bore of the second part.

3. The seal of claim 2, wherein the first part of the casing includes a generally annular disk.

4. The seal of claim 1, wherein the first part of the casing has an outer circumference, the second part of the casing has two opposing axial ends, and the connection location is proximal to the outer circumference of the first part and proximal to one of the two axial ends of the second part.

5. The seal of claim 1, wherein:
the first part of the casing has an outer circumferential surface and a radial surface extending inwardly from the outer circumferential surface;
the second part has an outer circumferential surface; and
the connection location is offset radially-inwardly from the outer circumferential surface of the first part, such that a recess for receiving an outer seal is defined between a portion of the radial surface of the first part and a portion of the outer circumferential surface of the second part.

6. The seal of claim 5, wherein the second part of the casing has two opposing axial ends, one of the two axial ends being connected with the first part of the casing at the connection location, and an inwardly-bent portion proximal to the one axial end and defining a portion of the recess.

7. The seal of claim 1, wherein the first part of the casing has an inner circumferential surface and the sealing element is molded onto the inner circumferential surface of the first part of the casing.

8. The seal of claim 7, wherein the sealing element is bonded onto the inner circumferential surface of the first part of the casing.

9. The seal of claim 1, wherein:
the first part of the casing has an inner circumferential surface and a radial surface; and
the sealing element includes an axially-extending surface engaged with the inner surface of the first part of the casing, and a radially-extending surface engaged with the radial surface of the first part of the casing.

10. A method of forming a seal, comprising:
attaching a sealing element to a first, generally radially-extending part of a casing, the sealing element being configured to seal with a relatively movable member;
modifying a dimension of the first part to meet a specification; and
attaching a second, generally axially-extending part of the casing to the first part.

11. The method of claim 10, wherein attaching the second part of the casing to the first part occurs after attaching the first part of the casing to the sealing element.

12. The method of claim 10, wherein modifying the dimension of the first part occurs prior to attaching the second part to the first part.

13. The method of claim 10, wherein attaching the sealing element to the first part of the casing comprises bonding the sealing element to the first part, molding the sealing element to the first part, or both.

14. The method of claim 10, wherein attaching the sealing element to the first part of the casing comprises attaching a shoulder formed in the sealing element to a radial inner portion of the first part.

15. The method of claim 10, wherein modifying the dimension of the first part comprises removing a radially-outer portion of the first part.

16. The method of claim 10, wherein attaching the second part of the casing to the first part comprises welding or soldering the first and second parts together at a connection location.

17. The method of claim 16, wherein the connection location is proximal to an outer circumference of the first part of the casing.

18. The method of claim 16, wherein the connection location is offset from an outer circumference of the first part of the casing along an axial face of the first part, wherein the first part and the second part together define an outer recess, the method further comprising receiving a seal into the outer recess.

19. A seal for a shaft, comprising:
a casing including a first part and a second part, the first part having a generally-annular disk shape and defining a radial surface, and the second part having a generally tubular shape including a first axial end and a second axial end, the first axial end of the second part being connected to the radial surface of the first part at a connection location, and at least a portion of the first part extending radially inward from at least a portion of the second part; and
a generally annular sealing element coupled with the first part of the casing and configured to seal with the shaft.
